(19) United States
(12) Patent Application Publication
(10) Pub. No.: US 2010/0214596 A1
(43) Pub. Date: Aug. 26, 2010

(54) Routing Component Ready Commands

(76) Inventors: Kelvin Hasseler, Murriela, CA (US); James Hasler, San Diego, CA (US); Yaguang Liu, San Diego, CA (US); Hyoen-Mu Yoo, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/393,106

(22) Filed: Feb. 26, 2009

(51) Int. Cl. G06F 3/12

(52) U.S. Cl. 358/1.15

(57) ABSTRACT

Commands from a central controller of a printing system are received at a first component of a printing system. The commands include component ready commands and non-component ready commands. The component ready commands are routed unaltered to a second component of the printing system.

### BACKGROUND

A printing system utilizes ink, toner, or other substance or process to form images on print media. An industrial printing system may be used for high-throughput applications such as printing photographs, forms, advertisements, lottery tickets, and the like. The assembly of an industrial printing system may be accomplished by integrating components from one or more vendors. For example, an assembler may integrate a paper handling component, a print management component, one or more printing components, and a servicing component from one or more vendors. The paper handling component is responsible for feeding print media through the printer system. The servicing component is responsible for maintaining printing components such as print heads. The print management component is responsible for causing the printing components to produce a desired image. The assembler may coordinate the operation of these components using a central controller that directs the overall imaging process.

An exemplary print management component is configured to receive printing commands such as a print job from a printer driver and, in response, cause the formation of desired images on a print medium. In doing so, the print management component processes the print job to produce device ready print data for causing printing components such as print heads to form the desired images. The print management component is configured with a limited set of processing capabilities. For example, the print management component may only be capable of causing the formation of images under a certain size or causing the formation of images on a certain type or size of print media. If certain unsupported capabilities are desired, the vendor redesigns the print management component to meet those desires.

### DRAWINGS

FIG. 1 is an exemplary diagram of an environment in which various embodiments may be implemented.

FIG. 2 is an exemplary diagram depicting the physical and logical components of a printing system according to an embodiment.

FIG. 3 is an exemplary diagram depicting the physical and logical components of a print management component according to an embodiment.

FIG. 4 is an exemplary diagram depicting the physical and logical components of a dedicated controller according to an embodiment.

FIGS. 5-6 are flow diagrams depicting method implementations according to various embodiments.

### DESCRIPTION

Glossary: The following terms are used throughout the following specification.

Non-component ready commands: high-level commands that are not in a format that can be routed, unaltered, to a given component to cause that component to perform a particular task or tasks. To provide an example, a print head component is capable of forming an image on paper. A computer can deliver a print job defining that image. However, the print job is first processed to generate commands that can be discerned by the print-head. Such processing may include rasterizing, half-toning, and color mapping.

Component-ready commands: low-level commands that are in a format that can be routed, unaltered, to a given component to cause that component to perform a particular task or tasks. Continuing, with the above example, component ready commands can include component ready print data generated by processing a print job. The component ready print data can be communicated directly to and discerned by a print component such as a print head.

Printing system: a group of components capable of interacting to produce a printed image on a print medium.

Print component: a component of a printing system that is configured to for a desired image on a print medium.

Print data: commands directing a print component to produce a desired image. Print data may be component ready or non-component ready. Component ready print data (a subset of component ready commands) can be routed, unaltered, to a print component. Non-component ready print data is first processed to generate component ready print data. Again, such processing may include rasterizing, half-toning, and color mapping.

Directives: commands for a printing system component to take a given action. Directives may be component ready or non-component ready. Component ready directives (a subset of component ready commands) can be routed, unaltered, to a printing system component. Non-component ready directives are first processed to generate component ready directives.

Requests: commands for a printing system component to return requested information. Requests may be component ready or non-component ready. Component ready requests (a subset of component ready commands) can be routed, unaltered, to a printing system component. Non-component ready requests are first processed to generate component ready requests. Such requests may be a query for status information related to current operating state of the printing system. For example, a request may be for current consumable levels or usage rates. Another request may be for any error or warning indicators.

Introduction: In a typical printing environment, a user causes a host computer to generate and send a print job to a printer. The printer accepts and processes the print job to generate component ready print data that can be delivered to printing components such as print heads. Such processing can, for example, include raster image processing, color mapping, scaling, and half-toning. On a relative scale, the print job represents a series of higher level commends while the component ready print data represents a series of lower level commands. Inherent processing limitations can prevent the printer from delivering lower level component ready print data that might otherwise be desired.

Various embodiments described below were developed in an effort to provide a print management component capable of accepting component ready print data that can be delivered unaltered to printing components. Such allows a first vendor to deploy the same version of the print management component for integration in any number of dissimilar printing systems. For each printing system, a second vendor is able to design a central controller for supplying the component ready print data that meets the particular needs of a given customer.

To maintain the proprietary nature of certain functions, the print management component may be configured to receive certain higher level instructions. The print management component processes the higher level instructions to perform requested tasks. Such tasks may include powering the print component, guiding the servicing of the print component, reporting data related to consumable levels, and reporting warnings or errors.

In an exemplary implementation, a print management component is configured to receive component ready print data via a first interface. The print management component routes that print data, unaltered to a print head. The print management component is also configured to receive higher level commands via a second interface. The print management component then processes the higher-level commands to generate component ready commands that can be communicated to a give printing system component. The first interface, for example, may include a group of data lines for communicating pen data to the print head. The second interface, for example, may be a network or serial interface. Thus, the print management component receives and processes non-component ready commands while it routes component ready print data directly to the print head.

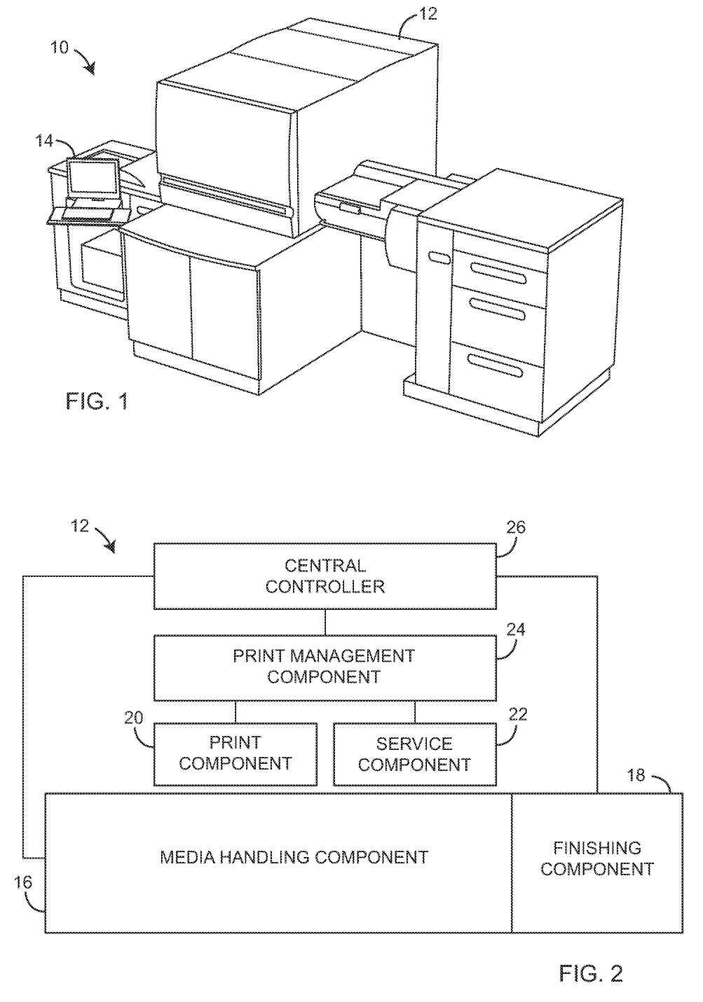

Components: FIG. 1 depicts an exemplary environment 10 in which various embodiments may be implemented. Environment 10 is shown to include printer system 12 and host 14. Printer system 10 represents generally an assembly of components configured to produce printed images of print media. Printing system 12, for example, may be used for printing photographs, forms, advertisements, lottery tickets, and the like. Host 14 represents generally any computing device capable communicating print jobs to print system 12. Host 14 may also supply a user interface allowing a user obtain status information and to configure printing system 12.

FIG. 2 is an exemplary block diagram of printing system 12. In this example, printing system 12 is shown to include media handling component 16, finishing component 18, print component 20, service component 22, print management component 24, and central controller 26. Media handling component 16 represents generally any combination of hardware and programming capable of transporting print media through print system 12. Print media may include paper sheets, a continuous web, or any other media on which a print image can be formed. Finishing component 18 represents generally any combination of hardware and programming capable of performing a finishing operation on print media. Such finishing operations include cutting, folding, laminating or any other action that affects the physical nature of the print medium.

Print component 20 represents generally any combination of elements capable of being utilized to form desired images on print media. In a given example, print component 20 may include a print head configured to dispense ink. In another example, print component 20 may be configured to fuse toner to print media. Service component 22 represents generally any combination of elements capable of being utilized to service print component 20. Where, for example, print component includes a print head, service component 22 may be configured to function as a spittoon, pen wiper, and color and alignment calibrator.

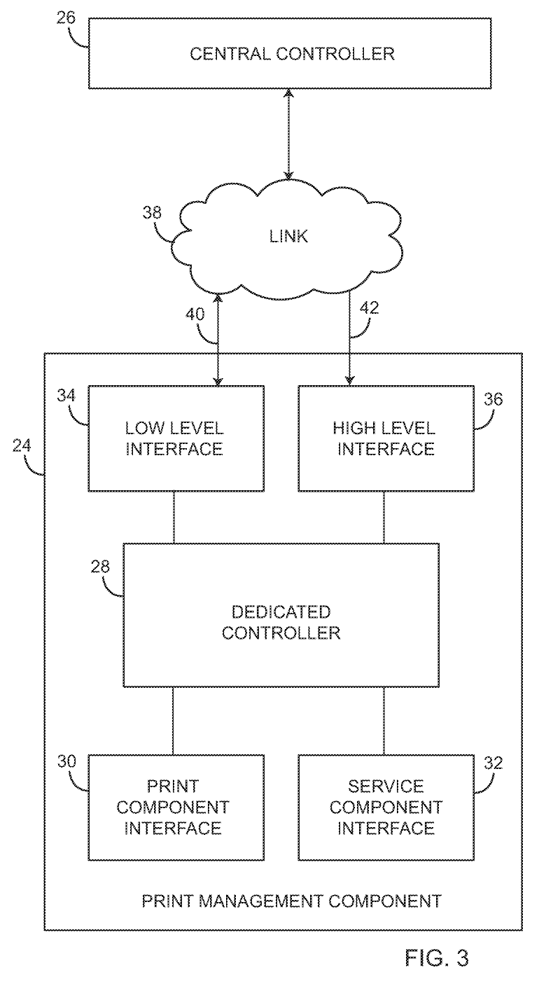

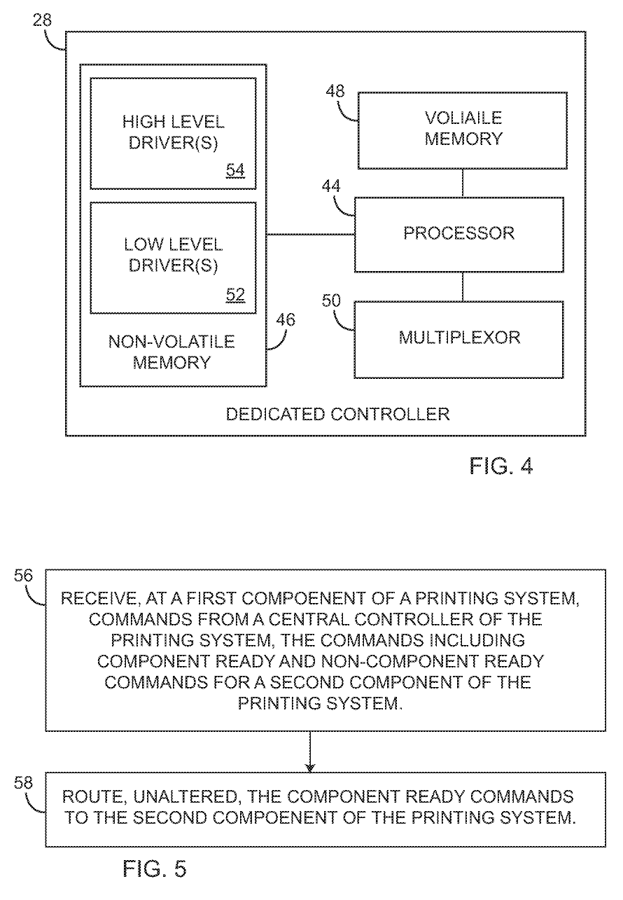

Discussed in more detail below with reference to FIGS. 3 and 4, print management component 24 represents generally any combination of hardware and programming capable of guiding the operation of print component 20 and service component 22. In particular, print management component 26 is responsible for communicating commands to print component 20 and service component 22. Commands communicated by print management component 24 can include both directives to perform a particular tasks as well as status queries. A given directive may cause print component 20 to form desired images on print media. Another directive may cause service component 22 to perform one or more functions. A status query may direct print component 20 to report errors or warnings as well and other status information related to consumable usage and levels for items such as ink or toner.

Central controller 26 represents generally any combination of elements capable of coordinating the operation of components 16-24. In a given implementation, central controller receives a print job from host 14 (FIG. 1). The print job, for example, may be for the printing of a series of photographs, multiple copies of an advertising brochure, or even lottery tickets. Central controller 26 then communicates commands causing components 16-24 to produce the print job. Such commands cause media handling component 16 to feed print media through print system 12, print management component 24 to guide print component 20 in forming desired images on the print media, and finishing component 18 to performing a finishing operation such as cutting or perforating.

As discussed in more detail below, print component 20 may include one or more print heads. Print component is configured to receive component ready commands that control the individual firing of any number of nozzles. In other words, the printing instructions contained in a print job received by central controller 26 are processed to generate component ready commands that can be communicated to print component 20. Central processor 26 is configured to process those print instructions to generate the component ready commands and communicate the component ready commands to print management component 24. Print management component 24 then routes those component ready commands, unaltered, to print component 20. Central controller 26 may also communicate non-component ready commands to print management component 24. Print management component 24 is then responsible for processing those commands to generate component ready commands to be communicated to one or both of print component 20 and service component 22.

FIG. 3 is an exemplary block diagram illustrating the physical and logical components of print management component 24. As shown, print management component 24 includes dedicated controller 28, print component interface 30, service component interface 32, low level interface 34, and high level Interface 36. Print management component 24 is coupled to central controller 26 via link 38. Link 38 represents generally one or more cable, wireless, or remote connections via one or more of a hard-wired direct link, an infrared link, a radio frequency link, and/or any other connector or system that provides electronic communication between central controller 26 and print management component 24.

Dedicated controller 28 represents generally any combination of hardware and programming capable of processing non-component ready commands to generate component ready commands. Dedicated controller is responsible for routing component ready commands to print component 20 and service component 22 (FIG. 2) via print component interface 30 and service component interface 32. In operation, dedicated controller 28 is configured to receive both component ready commands and non-component ready commands. Dedicated controller 28 is configured to route the component ready commands, unaltered, to print component 20. In other words, dedicated controller does not process the component ready commands. The component ready commands can include directives and requests. Requests may be queries for component status information concerning items such as available consumable levels, consumable level usage, warnings, and errors. Directives are instructions for performing a particular task.

Service component interface 32 represents generally any combination of elements capably of being utilized to communicate directives and requests to and from service component 22. Service component 22 from time to time may communicate directives, referred to as print data, for causing print component 20 to perform a selected task. The print data may or may not be component ready. If component ready, dedicated controller 28 routes the print data, unaltered, to print component 20 via print component interface 30. If not, dedicated controller processes the print data commands to generate component ready print data to route to print component 20. Dedicated controller 28, from time to time, may route commands to service component 22 via service component interface 32. In one implementation, those routed commands may be component ready. In another implementation, service component 22 incorporates its own dedicated controller capable of processing non-component ready commands as needed.

Print component interface 30 represents generally any combination of elements capable of utilizing component ready directives to cause print component 20 to perform a specific task and to utilize component ready requests to obtain or otherwise identify requested status information. Component ready directives routed to print component 32 can be referred to as component ready print data. Print component interface 30 is configured to utilize component ready print data to cause print component 20 to form desired images and other tasks. In a given implementation, print component interface 30 may be an application specific integrated circuit (ASIC) configured to cause the selective firing of the various nozzles provided by one or more print heads as guided by the component ready print data. Where print component 20 includes one or more print heads, such component ready print data can include pen data and timing data communicated to print component interface 30 via a number of data lines and a clock line. The pen data communicates nozzle firing instructions while the timing data is used for synchronizing the operation of print component 20 with media handling component 16. In other words, as media handling component 16 is feeding a print medium through printing system 12, the timing data allows print component 20 such as a print head to eject ink at the appropriate time to form a desired image.

Low level interface 34 represents generally any combination of elements capable of receiving component ready commands from central controller 26. High level interface represents generally any combination of elements capable of receiving non-component ready commands from central controller 26 and returning responses to central controller 26. The terms “high” and “low” are used only to distinguish between the types of commands. Component ready commands can be referred to as low level commands. Non-component ready commands can be referred to as high level commands that are to be processed to generate low level commands. In the example of FIG. 3, link 38 is shown to provide two communication channels 40 and 42 between central controller 26 and print management component 24. Channel 40 carries the component ready commands, while channel 42 carries the non-component ready commands and responses. To communicate component ready print data, channel 40 may include a number of data lines and a clock line as discussed above.

FIG. 4 is an exemplary block diagram illustrating the physical and logical components of dedicated controller 28. As depicted, dedicated controller 28 includes processor 44, non-volatile memory 46, volatile memory 48, and multiplexor 50. Processor 44 represents generally any computing element or combination of elements capable of processing instructions contained in non-volatile memory 46. In processing those instructions, processor 44 utilizes volatile memory for temporary data storage. Processor utilizes multiplexor 50 to switch between inputs for routing print ready component ready print data to print component 20 via print component interface 30. Examples of such inputs include low level interface 34 and service component interface 32. Additionally, processor 44 may also serve as an input to multiplexor 50 in cases where processor 44 is responsible for processing non-component commands to generate component ready print data.

Non-volatile memory 46 is shown to include low level driver(s) 52 and high level driver(s) 54. Low level driver(s) represent generally any programming that when executed by processor 44 causes processor 44 to control multiplexor to switch to a selected input for routing component ready print data to print component 20 via print component interface 30. High level driver(s) 54 represent generally any programming that when executed by processor 44 causes processor 44 to process non-component ready commands to generate component ready commands. In one example, the component ready commands may be component ready print data. In this case, low level driver(s) 52 would cause processor 44 to switch the input of multiplexor 50 to receive and rout the component ready print data on to print component 20. As noted above the terms “low” and “high” are used only to distinguish between the types of commands. Component ready commands can be referred to as low level commands. Non-component ready commands can be referred to as high level commands that are to be processed to generate low level commands.

Operation: FIG. 5 is an exemplary flow diagram depicting steps taken to implement an embodiment. In discussing FIG. 5, reference is made to the diagrams of FIGS. 2-4. These references are made to provide contextual examples. Implementation, however, is not limited to those examples. Commands are received at a first component of a printing system from a central controller of the printing system (step 56). The commands include component ready and non-component ready commands for a second component of the printing system. Looking back to FIG. 3, print management component 24 may accomplish step 56 by receiving the component-ready commands via low level interface 34 and receiving the non-component ready commands via high level interface 36.

The component ready commands are routed, unaltered, to the second component of the printing system (step 58). In an exemplary implementation, the component ready commands may be component ready print data. Referring to FIG. 4, step 58 may be accomplished by causing multiplexor 50 to switch its input to receive the component ready commands allowing those commands to be routed to print component 20 (FIG. 2) via print component interface 30 (FIG. 3). Where the component ready print data is intended for a print head, the component ready print data may include pen firing data communicated via a plurality of data lines and timing information communicated via a clock line. The non-component ready commands may, for example, be a directive or a request. Referring to FIG. 2, a directive may include non-component ready print data intended for print component 20 and received from a third component of the printing system such as service component 22. A request may be a request from central controller 26 regarding the status of the second component or even the third component of the printing system.

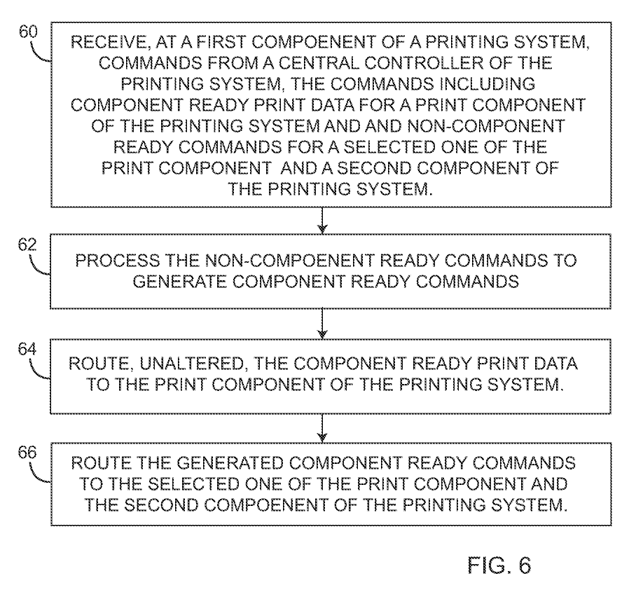

FIG. 6 is an exemplary flow diagram depicting steps taken to implement another embodiment. In discussing FIG. 6, reference is again made to the diagrams of FIGS. 2-4. These references are made to provide contextual examples. Implementation, however, is not limited to those examples. Commands are received from a central controller of a printing system (step 60). The commands are received at a first component of that printing system. The commands include component ready print data for a print component and non-component ready commands for a selected one of the print component and a second component of the printing system.

The non-component ready commands are processed to generate component ready commands (step 62). The non-component ready commands may, for example, be a directive or a request. Referring to FIG. 2, a directive may include non-component ready print data intended for print component 20 and received from a third component of the printing system such as service component 22. A request may be a request from central controller 26 regarding the status of print component 20 or of service component 22 of the printing system.

The component ready print data is routed, unaltered, to the print component of the printing system (step 64). Referring to FIG. 4, step 64 may be accomplished by causing multiplexor 50 to switch its input to receive the component ready print data allowing those commands to be routed to print component 20 (FIG. 2) via print component interface 30 (FIG. 3).

The component ready commands generated in step 62 are routed to the selected one of the print component and the second component of the printing system (step 66). In one example, the non-component ready commands include a directive that is processed in step 62 to generate component ready print data that is routed to print component 20 in step 66. Again routing may be accomplished by causing multiplexor 50 (FIG. 4) to switch its input, thus, routing the component ready print data to print component 20 (FIG. 2) via print component interface 30 (FIG. 3). In another example, the non-component ready commands include a request from central controller 26 that is processed in step 62 to generate a component ready request routed to a selected one of print component 20 and service component 22. A response to the request routed in step 66 is received from the selected component. That response is then communicated to central controller 26.

Conclusion: The printing system 12 shown in FIG. 1 is an exemplary system in which embodiments of the present invention may be implemented. Implementation, however, is not so limited. Embodiments can be implemented in any environment in which it is desirable to receive and route component ready commands. The diagrams of FIGS. 2-4 show the architecture, functionality, and operation of various embodiments. The block dedicated controller 28 in FIGS. 3-4 is defined in part as a program. Dedicated controller 28 may represent, at least in part, a module, segment, or portion of code that comprises one or more executable instructions to implement the specified logical function(s). Dedicated controller 28 may also represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a hard drive, a random access memory (RAM), a read-only memory (ROM), an erasable programmable read-only memory, or a portable disc.

Although the flow diagrams of FIGS. 5-6 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method, comprising:
receiving, at a first component of a printing system, commands from a central controller of the printing system, the commands including component ready commands and non-component ready commands; and
routing, unaltered, the component ready commands to a second component of the printing system.

2. The method of claim 1, wherein:
the second component is a print component configured to form a desired image on a print medium;
the component ready commands include component ready print data; and
routing, unaltered, the component ready commands comprises routing, unaltered, the component ready print data to the print component causing the print component to form an image as guided by the component ready print data.

3. The method of claim 2, wherein the component ready print data includes timing data for use in synchronizing operation of the print component with a media handling component configured to feed a print medium through the printing system.

4. The method of claim 1, wherein the received commands include a directive that is not component ready, the method comprising;
processing the directive to generate a component ready directive; and
routing the component ready directive to a selected one of the second component and a third component of the printing system.

5. The method of claim 1, wherein the commands include a request that is not component ready, the method comprising:
processing the request to generate a component ready request; and
routing the component ready request to a selected one of the second component and a third component of the printing system.

6. The method of claim 5, comprising:
receiving from the selected one of the second component and the third component a response to the component ready request; and
communicating data indicative of the response to the central controller.

7. The method of claim 6, wherein:
the second component is a print component configured to form a desired image on a print medium;
the component ready commands include component ready print data;
routing, unaltered, the component ready commands comprises routing, unaltered, the component ready print data to the print component causing the print component to form an image as guided by the component ready print data.
the component ready request is a query; and
receiving from the selected one of the second component and the third component comprises receiving a response to the query.

8. A print management component for use in a printing system, the print management component comprising a first interface, a second interface, and a dedicated controller, wherein;
the first interface is a communication interface between the dedicated controller and a central controller;
the second interface is communication interface between the dedicated controller and another component of the printing system;
the dedicated controller is configured to:
receive via the first interface, commands from the central controller of the printing system, the commands including component ready commands and non-component ready commands; and
route, unaltered, the component ready commands to the other component of the printing system via the second interface.

9. The print management component of claim 8, wherein:
the other component is a print component configured to form a desired image on a print medium;
the component ready commands include component ready print data; and
the dedicated controller is configured to route, unaltered, the component ready print data to the print component via the second interface causing the print component to form an image as guided by the component ready print data.

10. The print management component of claim 9, wherein the wherein the component ready print data includes timing data for use in synchronizing operation of the print component with a media handling component configured to feed a print medium through the printing system.

11. The print management component of claim 8, wherein the received commands include a directive that is not component ready, the print management component being configured to:
process the directive to generate a component ready directive; and
route the component ready directive to the other component of the printing system.

12. The print management component of claim 8, wherein the commands include a request that is not component ready, the print management component being configured to:
process the request to generate a component ready request; and
route the component ready request to the other component of the printing system via the second interface.

13. The print management component of claim 12, wherein the dedicated controller is configured to:
receive a response to the component ready request from the other component of the printing system via the second interface; and
communicate data indicative of the response to the central controller via the first interface.

14. The print management component of claim 13, wherein:
the other component is a print component configured to form a desired image on a print medium;
the component ready commands include component ready print data;
the component ready request is a query;
the dedicated controller is configured to route, unaltered, the component ready print data to the print component causing the print component to form an image as guided by the component ready print data and to receive a response to the query from the print component via the second interface.

15. A system, comprising:
means for receiving, at a first component of a printing system, commands from a central controller of the printing system, the commands including component ready print data and a non-component ready command;
means for processing the non-component ready command to generate a component ready command;
means for routing, unaltered, the component ready commands to a print component of the printing system to cause the print component to form an image on a print medium; and
means for routing the component ready command to the print component of the printing system.
